(19) United States
(12) Patent Application Publication
(10) Pub. No.: US 2025/0016621 A1
(43) Pub. Date: Jan. 9, 2025

(54) Throughput Predictor And Flow Load Balancer

(71) Applicant: Cisco Technology, Inc., San Jose, CA (US)

(72) Inventors: Jerome Henry, Pittsboro, NC (US); Pascal Thubert, Roquefort-les-Pins (FR); Jean Philippe Vasseur, Issy Les Moulineaux (FR)

(73) Assignee: Cisco Technology, Inc., San Jose, CA (US)

(21) Appl. No.: 18/767,745

(22) Filed: Jul. 9, 2024

Related U.S. Application Data
(60) Provisional application No. 63/512,651, filed on Jul. 9, 2023.

(51) Int. Cl. H04W 28/086; H04W 28/08; H04W 84/12

(52) U.S. Cl. CPC H04W 28/086; H04W 28/0983; H04W 84/12

(57) ABSTRACT

Predicting network throughput and balancing network loads may be provided. Predicting network throughput and balancing network loads can comprise receiving traffic information from a plurality of Access Points (APs). Based on the traffic information, traffic associated with the plurality of APs can be modeled. Based on the modeled traffic, a gain in AP efficiency for one or more APs of the plurality of APs can be modeled when modifying Station (STA) traffic of a STA. A recommendation can be sent to one or more recipient APs of the plurality of APs, wherein the recommendation indicates the gain in AP efficiency for the one or more APs when modifying the STA traffic.

### RELATED APPLICATION

Under provisions of 35 U.S.C. § 119 (e), Applicant claims the benefit of and priority to U.S. Provisional Application No. 63/512,651, filed Jul. 9, 2023, the disclosure of which is incorporated herein by reference in its entirety.

### TECHNICAL FIELD

The present disclosure relates generally to predicting network throughput and balancing network loads.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for predicting network throughput and balancing network loads in accordance with aspects of the present disclosure.

FIG. 2 is a block diagram of a network mapping information table in accordance with aspects of the present disclosure.

FIG. 3 is a flow chart of a method for predicting network throughput and balancing network loads in accordance with aspects of the present disclosure.

FIG. 4 is a block diagram of a computing device in accordance with aspects of the present disclosure.

FIG. 5 is a block diagram of a wireless device in accordance with aspects of the present disclosure.

### DETAILED DESCRIPTION

### Overview

Predicting network throughput and balancing network loads may be provided. Predicting network throughput and balancing network loads can comprise receiving traffic information from a plurality of Access Points (APs). Based on the traffic information, traffic associated with the plurality of APs can be modeled. Based on the modeled traffic, a gain in AP efficiency for one or more APs of the plurality of APs can be modeled when modifying Station (STA) traffic of a STA. A recommendation can be sent to one or more recipient APs of the plurality of APs, wherein the recommendation indicates the gain in AP efficiency for the one or more APs when modifying the STA traffic.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Wireless network (e.g., Wi-Fi) cells are intended to serve Stations (STAs) within each cell's range by providing connectivity and sufficient Radio Frequency (RF) performance. However, as the density of STAs increases in a cell's range, the efficiency of the cell can decrease as it tries to provide connectivity to many STAs. STAs in a high density environment may therefore need to wait to communicate via the network when other STAs use the medium, STAs that are close to an Access Point (AP) providing access to the network may experience reduced throughput caused by the traffic of STAs that are further from the AP (e.g., STAs using lower data rate, using a lower Modulation and Coding Scheme (MCS), and/or taking longer to transmit a given payload). A single STA at the edge of a cell can if fact cause enough collisions, such as collisions occurring because of the hidden node issue, and delays to degrade the user experience of STAs near the AP to a level the network provider finds unacceptable. In some situations for example, transmission times can be more than twenty-four times slower than intended or otherwise expected operation because of one or more STAs positioned at the edge of a cell.

For past wireless network standards implemented when network coverage was sparse and access was entirely unscheduled, network performance degradation due to STAs positioned at a cell edge was just a downside of mobility. With scheduling and Multi-Link Operations (MLO) in current standards and higher reliability targeted for new standards (e.g., the Institute of Electrical and Electronics Engineers (IEEE) 802.11bn), this network performance degradation can be addressed to provide a better user experience including when some devices are at the edge of the cell. Methods for predicting the contributions of STAs to the loads of cells and the gain in overall airtime if part or all of a STA's traffic is moved to a neighboring cell can be used to distribute the loads between cells and improve network performance. The predictions can be shared between APs of neighboring cells to determine how to distribute STA traffic. The predictions can also be shared with heavy airtime-consumer STAs to help the STAs arbitrate the distribution of the flow load among APs or switch their flow to more efficient cells.

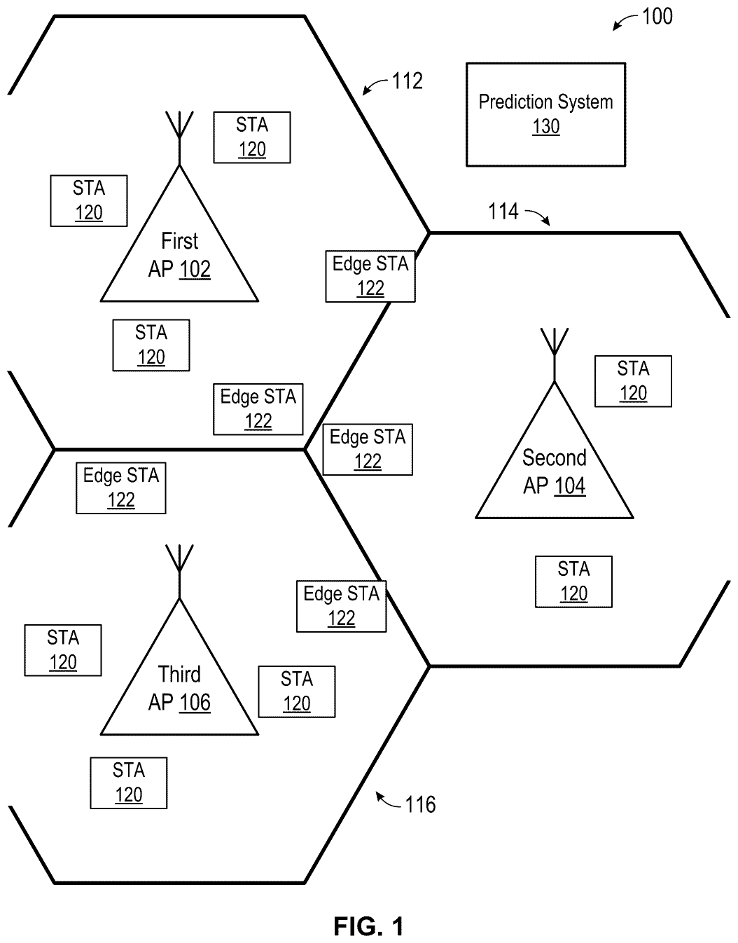

FIG. 1 is a block diagram of an operating environment 100 for predicting network throughput and balancing network loads. The operating environment 100 includes a first AP 102, a second AP 104, and a third AP 106. The first AP 102, the second AP 104, and the third AP 106 may enable devices within range of the respective AP to connect to the network. The first AP 102 has a first cell 112, the second AP 104 has a second cell 114, and the third AP 106 has a third cell 116. The edges of the first cell 112, the second cell 114, and the third cell 116 as shown in the operating environment 100 are an example and may be different in other examples (e.g., different sizes, shapes, configurations, etc.). The ranges of the first AP 102, the second AP 104, and the third AP 106 may overlap, so multiple APs may be able to communicate with devices near or past the respective cell ranges.

The range of the first AP 102, the second AP 104, and the third AP 106 may extend past the boundary of the respective cells, but the signals the APs can generate may grow weaker and the AP may otherwise have issues when communicating with devices near or past the edge of the respective cells. The performance of the first AP 102, the second AP 104, the third AP 106, and the fourth AP 108 may therefore be negatively impacted when communicating with devices near and past the edges of the respective cells, including reduced throughput, collisions, delays, and/or the like. The first AP 102, the second AP 104, the third AP 106 and/or other devices may predict network throughput and balance network loads as described herein to address the impacts of communicating with devices near or past the edges of cells.

The operating environment 100 also includes STAs 120 and edge STAs 122. The STAs 120 and the edge STAs 122 can be any device (e.g., a smart phone, a tablet, a personal computer, a server, etc.) that connects to the network, such as to communicate with other devices on the network. The STAs 120 may be positioned in one of the first cell 112, the second cell 114, or the third cell 116 and be close enough to the respective APs to not impact the APs. The edge STAs 122 may be close enough to the edge of cell, and therefore far enough from one or more respective APs, to impact the APs. Thus, the STAs 120 and the edge STAs 122 are identified differently based on the proximity to the edges of the cells. A STA 120 that moves to the edge of the cell can become an edge STA 122, and an edge STA 122 that moves closer to a respective AP can become a STA 120.

The operating environment 100 also includes a prediction system 130. The prediction system 130 may be positioned to communicate with the first AP 102, the second AP 104, the third AP 106, and/or other neighboring APs. The prediction system 130 may be a device that can model traffic of the first AP 102, the second AP 104, the third AP 106, and/or other neighboring APs and predict gains in network performance when balancing the loads of the first AP 102, the second AP 104, the third AP 106, and/or other neighboring APs, particularly by distributing the loads of the edge STAs 122. The prediction system 130 may be a component of one of the APs, a component of a controller (e.g., a Wireless Local Area Network controller), and/or some other network device in certain example implementations. There may be a different number of devices in the operating environment 100 in other examples, including APs, STAs, prediction systems, and/or other network devices.

In certain embodiments, the prediction system 130, the first AP 102, the second AP 104, the third AP 106, the STAs 120, and/or the edge STAs 122 can utilize machine learning to predict network throughput and balance network loads as described herein. In general, machine learning is concerned with the design and the development of techniques that take data (e.g., network statistics, performance indicators) as input, and recognize complex patterns in the data. One common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=ax+b*y+c and the cost function would be the number of misclassified points. The learning process then operates by adjusting the parameters a, b, c such that the number of misclassified points is minimal. After this optimization phase (or learning phase), the model M can be used to classify new data points. Often, M is a statistical model, and the cost function is inversely proportional to the likelihood of M, given the input data.

In various implementations, the prediction system 130, the first AP 102, the second AP 104, the third AP 106, the STAs 120, and/or the edge STAs 122 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. Unsupervised techniques do not require a training set of labels. While a supervised learning model may look for previously seen patterns that have been labeled as such, an unsupervised model may instead look to whether there are sudden changes or patterns in the behavior of the metrics. Semi-supervised learning models are a mixed approach that use a reduced set of labeled training data.

Example machine learning techniques that the prediction system 130, the first AP 102, the second AP 104, the third AP 106, the STAs 120, and/or the edge STAs 122 can employ may include Nearest Neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), Support Vector Machines (SVMs), Generative Adversarial Networks (GANs), Long Short-Term Memory (LSTM), logistic or other regression, Markov models or chains, Principal Component Analysis (PCA) (e.g., for linear models), Singular Value Decomposition (SVD), Multi-Layer Perceptron (MLP) Artificial Neural Networks (ANNs) (e.g., for non-linear models), replicating reservoir networks (e.g., for non-linear models, typically for timeseries), random forest classification, and/or the like.

In further implementations, the prediction system 130, the first AP 102, the second AP 104, the third AP 106, the STAs 120, and/or the edge STAs 122 may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, Generative Adversarial Networks (GANs), Large Language Models (LLMs), other transformer models, and/or the like.

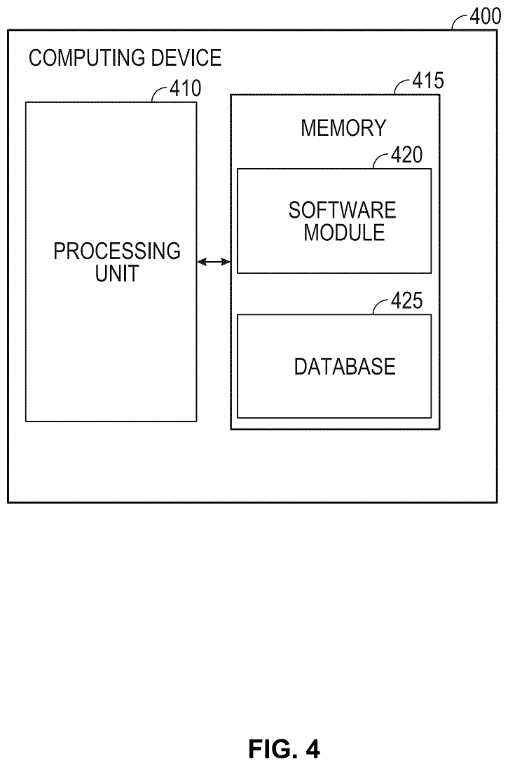

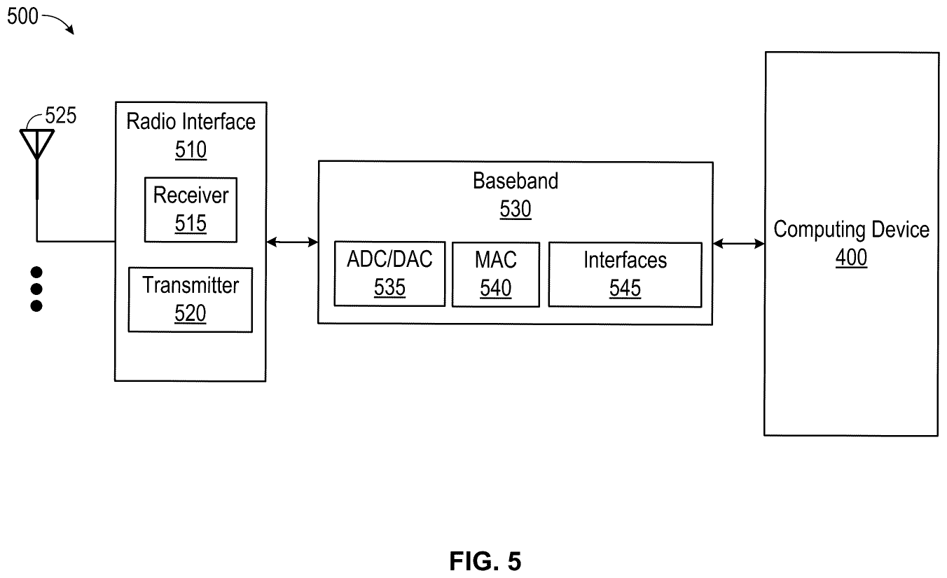

The elements described above of the operating environment 100 (e.g., the first AP 102, the second AP 104, the third AP 106, the STAs 120, the edge STAs 122, the prediction system 130, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 4 and 5, the elements of the operating environment 100 may be practiced in a computing device 400 and/or communications device 500.

To model the traffic of the network and predict gains in network performance when balancing the loads of the first AP 102, the second AP 104, and/or the third AP 106, the network may initially operate without input from the prediction system 130. Thus, the STAs 120 and the edge STAs 122 may be unrestricted and associate with the first AP 102, the second AP 104, and/or the third AP 106, and the STAs 120 and the edge STAs 122 can then transmit and receive traffic via the first AP 102, the second AP 104, and/or the third AP 106 as a typical network operates.

The first AP 102, the second AP 104, and/or the third AP 106 can each report traffic information the respective AP observes to the prediction system 130. The traffic information the APs report can include information identifying associated STAs (e.g., STAs 120 and/or edge STAs 122), information identifying the sender and receiver of traffic, frame durations, the MCS, STAs entering or leaving the AP's cell (e.g., the first cell 112, the second cell 114, the third cell 116), which STAs are using Multi-Link Device (MLD) capabilities or are MLD capable, traffic type, and/or the like. Thus, the prediction system 130 may receive sufficient traffic information to determine characteristics of the APs and the STAs and to model and predict the traffic that is occurring between the devices.

The prediction system 130 can create a model of the traffic in the cells of a network (e.g., the first cell 112, the second cell 114, the third cell 116) using the traffic information the APs provide to the prediction system 130. The model can represent the airtime consumption (e.g., airtime utilization represented as a percentage of an AP's available capacity) of STAs in each cell, including Downlink (DL) and Uplink (UL). The airtime consumption may depend on the total individual capacity of an AP, so the airtime consumption may vary for example between the first AP 102, the second AP 104, and the third AP 106. In certain example implementations, the model is a regression model the prediction system 130 creates using time series data. The prediction system 130 can model the airtime consumption by STAs over short intervals (e.g., a few hundred milliseconds to a few seconds) and longer intervals (ten or more of seconds) for tracking changes in the network (e.g., STAs changing position, STAs increasing/reducing traffic load, etc.). For example, the prediction system 130 can model the airtime consumption changes of STAs that are moving, such as closer to or further from an AP in the cell the STA is in, an STA moving to a new cell, and so on.

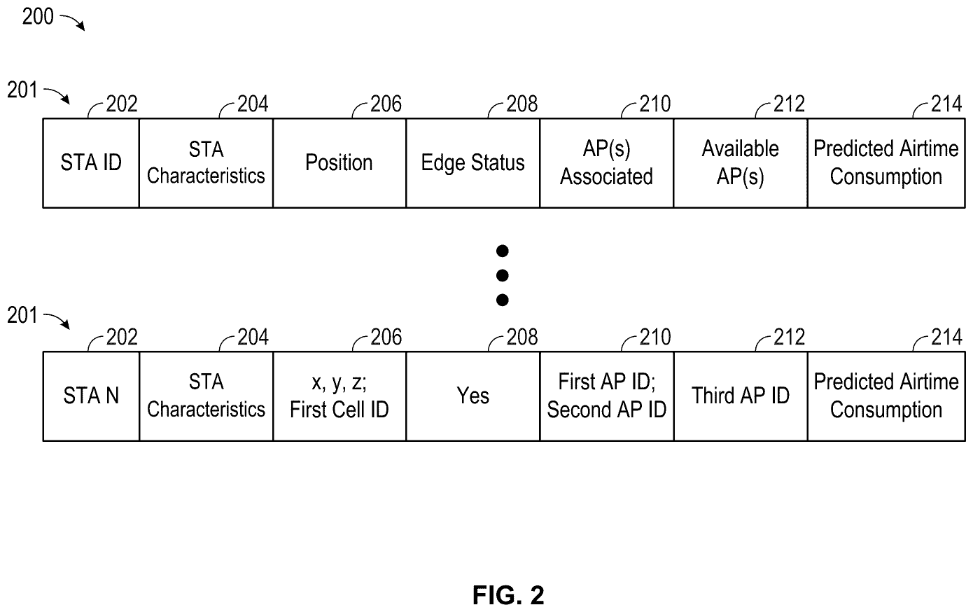

FIG. 2 is a block diagram of a network mapping information table 200. The network mapping information table 200 can include information for the STAs (e.g., the STAs 120 and the edge STAs 122) in the network. The network mapping information table 200 is an example virtual mapping of the STAs of the network. Based on feedback from the APs (e.g. the traffic information that can include a report of keepalive-probes from STAs are intervals, report of MLDs etc.), the prediction system 130 can construct a virtual map of STAs, such as the network mapping information table 200. For example, the virtual map can indicate STAs that associated to two neighboring AP radios or are otherwise MLDs, STAs that are associated to a single AP but could also associate to a neighboring AP (either as an MLD or as a single radio STA) are associated to a single STA but could not associate to another AP, and/or the like. Thus, the virtual mapping indicates the STAs that can have their traffic handled by one or more other APs for load balancing purposes.

The network mapping information table 200 can include an STA mapping 201 for each STA in the network. Each STA mapping 201 can include an STA ID field 202 to indicate the ID of the STA associated with the respective STA mapping 201, a STA characteristics field 204 to indicate characteristics of the STA (e.g., MLD capable or not), a position field 206 to indicate the physical position of the STA and/or the cell the STA is positioned in, an edge status field 208 to indicate whether the STA is near a cell edge (e.g., an edge STA 122) or not (e.g., a STA 120), an AP association field 210 to indicate the one or more APs the STA is associated to, an available AP field 212 to indicate the one or more APs the STA can associate with (e.g., neighbor APs the STA is within range of), a predicted airtime consumption field 214 to indicate the predicted airtime consumption of the STA, and/or the like. Thus, the network mapping information table 200 can indicate STAs that associated to two neighboring AP radios or are otherwise MLDs, STAs that are associated to a single AP but could also associate to a neighboring AP (either as an MLD or as a single radio STA) are associated to a single STA but could not associate to another AP, and/or the like. The STA ID field 202, the STA characteristics field 204, the position field 206, the edge status field 208, the AP association field 210, the available AP field 212, and the predicted airtime consumption field 214 include one or more bits for indicating information in some implementations.

The prediction system 130 can model the contribution to airtime consumption of each STA in a cell. Thus, the prediction system 130 can model the total airtime consumption for different periods for each cell, including the first cell 112, the second cell 114, and the third cell 116 for example. The prediction system 130 may identify the edge STAs 122 that will consume comparatively large portions of airtime because of the distance from the AP(s) the edge STAs 122 are associated to. In some embodiments, the prediction system 130 stores the modeled airtime consumption of STAs in the predicted airtime consumption field 214. In other embodiments, the prediction system 130 can use other types of models and/or storage for modeling the predicted airtime consumption of STAs.

Once the prediction system 130 models the predicted airtime consumption of the STAs, the prediction system 130 models the gain in cell efficiency if an individual large cell airtime consumption contributor (e.g., an edge STA 122) is moved, assigned fewer resources, or removed from a respective cell. In certain embodiments, the gain in cell efficiency is represented by the airtime consumption suppressed and/or the percentage improvement of the total airtime utilization.

The gain obtained from allocating a STA fewer resources can require complex computation, for example because an application may react to starvation of resources. The gain obtained by moving traffic to another cell can also be difficult to model, because moving the traffic is not a mere addition to the neighboring cell traffic as each inserted frame will affect the flows of STAs already in that neighboring cell, causing additional delays, possible collisions, existing STAs change of behavior (e.g., grouping more packets, dropping off scheduled upstream slots, etc.) and the like. Thus, the prediction system 130 may utilize machine learning or artificial intelligent methods to generate the models based at least in part on evaluating potential effects from altering resource availability and moving traffic to other cells. In some embodiments, the prediction system 130 uses naïve Bayes to evaluate the effect of inserting individual frames of an STA into another cell flow. In certain embodiments, the prediction system 130 uses a regressor coupled with a booster (e.g., gradient booster) to evaluate the effect of inserting individual frames of an STA into another cell flow and minimizes the uncertainty resulting from the traffic insertion. The regressor may be multi-variate because the prediction system 130 may need to characterize the traffic type(s). The predicted values the regressor can generate are the airtime consumption as the regressor projects the contribution of traffic to the overall airtime consumption in a cell and predicts what the airtime consumption would be if traffic is moved to another cell or radio. The prediction system 130 may use other machine learning methods to evaluate the effect of inserting individual frames of an STA into another cell flow in other example implementations.

Based on the one or more models the prediction system 130 generates, the prediction system 130 can generate recommendations for distributing STA traffic, such as moving, allocating less resources, or removing STAs, and share the recommendations with each AP. In some embodiments, the prediction system 130 may aim to model the predicted airtime consumption by balancing the load of the APs so each AP has an airtime utilization equal to the AP's total capacity or less. For example, the prediction system 130 may generate a model by moving or assigning STA traffic between APs for each AP to have an airtime utilization of eighty percent or less to accommodate additional traffic that is not expected. The prediction system 130 can send the recommendations to the APs so the APs can perform load balancing according to the recommendations.

In some embodiments, the prediction system 130 may be a separate device such as a network controller, and the prediction system 130 can share the recommendation over the Distribution System (DS). In other embodiments, one or more of the APs may have a prediction system 130, and the one or more APs may each generate predictions and recommendations before sharing its recommendations with neighbor APs (e.g., Overlapping Basic Service Set (OBSS) APs) through via over-the-air management frames.

In certain embodiments, the APs shares the recommendation with each STA that is a heavy airtime consumer and which traffic could be moved to another cell, such as the edge STAs 122. For MLD STAs, the APs can recommend or otherwise instruct the STAs to move traffic to one or more other links. The APs can also indicate to the STAs the expected overall gain in network performance associated with moving traffic to the one or more other links. Thus, the APs can indicate that the gain in network performance is expected to be measurable both for the cell overall and for the moved STA in particular. For example, load balancing the APs enables the STA to move or otherwise exchange traffic via a cell with lower overall airtime utilization, where the STA can benefit from a higher MCS, and/or the like.

For single radio STAs that can be moved to other cells or otherwise exchange traffic via other cells, an AP can send a modified Basic Service Set (BSS) Transition Management (BTM) request (e.g., as described in IEEE 802.11v), indicating the STA to move to a new cell or otherwise exchange traffic via another cell, the expected gains, and/or the like. For STAs that cannot be moved to another cell, an AP can reduce the airtime allocated to the STA. For UL traffic, the AP can reduce the airtime allocation by reducing the allocated TXOPs when applicable, and/or slowing down the forwarding of Transmission Control Protocol (TCP) Acknowledges (ACKs) received. In some embodiments, the STA that cannot be moved to another cell must have traffic that is of TCP and has a low delay sensitivity type (e.g. file download) for the AP to reduce the airtime allocation.

By implementing the recommendations of the prediction system 130 to perform load balancing, APs, such as the first AP 102, the second AP 104, and the third AP 106, may ensure that there is sufficient airtime capacity to serve associated STAs. The network may thus have a higher overall throughput for neighboring cells with limited negative effects on any particular STA.

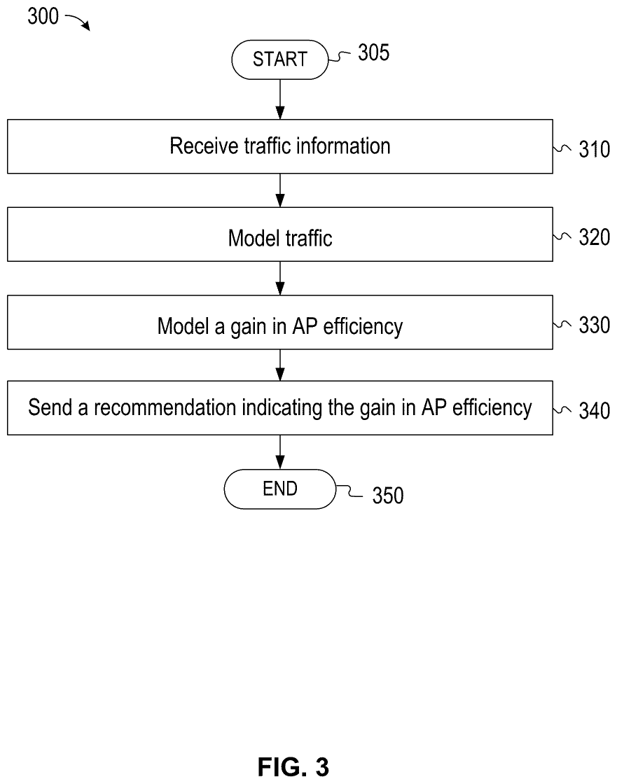

FIG. 3 is a flow chart of a method 300 for predicting network throughput and balancing network loads. The method 300 may begin at starting block 305 and proceed to operation 310. In operation 310, traffic information is received from a plurality of APs. For example, the first AP 102, the second AP 104, and the third AP 106 share traffic information with the prediction system 130. The traffic information may be information collected over a period of time, and the APs may periodically update the traffic information by sending the prediction system 130 updates as the APs collect more information. The traffic information can include information identifying associated STAs (e.g., the STAs 120 and the edge STAs 122 present in the AP's cell or otherwise associated with the respective AP), information identifying a sender and a receiver of traffic, frame duration information, MCS information, information identifying movement of STAs (e.g., STAs moving out of a cell, STAs moving into a cell, etc.), information identifying MLD capable STAs, information identifying traffic type(s), and/or the like.

In operation 320, traffic associated with the plurality of APs is modeled. For example, the prediction system 130 models the traffic of the APs (e.g., the traffic in the first cell 112, the second cell 114, and the third cell 116) based on the traffic information. Modeling the traffic associated with the plurality of APs can comprise using a regressor to model the traffic based on time series data of the traffic information. Additionally, modeling the traffic associated with the plurality of APs can include identifying one or more STAs associated to two or more APs of the plurality of APs, identifying one or more STAs associated to a single AP and capable of associating to one or more neighboring APs, identifying one or more STAs not capable of associating to one or more neighboring APs, and/or the like.

In operation 330, a gain in AP efficiency for one or more APs of the plurality of APs is modeled when modifying STA traffic of a STA. For example, the prediction system 130 models a gain in efficiency, such as improved airtime consumption, for the first AP 102, the second AP 104, and/or the third AP 106 by modifying the STA traffic of one or more STAs using the modeled traffic. The prediction system 130 may comprise identify the STA is an edge STA 122, and thus a high percentage airtime consumption STA, and determine to model the gain in AP efficiency by modifying the STA traffic of the STA based on based on identifying the STA is an edge STA 122. Modifying the STA traffic can comprise any one of removing the STA traffic from a current AP of the plurality of APs, moving the STA traffic to a new AP of the plurality of APs, reducing an airtime allocation for the STA traffic, and/or the like. Modeling the gain in AP efficiency can include using naïve Bayes to evaluate an effect of modifying the STA traffic by moving the STA traffic to a new AP of the plurality of APs or using a regressor coupled with a booster that minimizes uncertainty resulting from modifying the STA traffic by moving the STA traffic to the new AP of the plurality of APs.

In operation 340, a recommendation is sent to one or more recipient APs of the plurality of APs, wherein the recommendation indicates the gain in AP efficiency for the one or more APs when modifying the STA traffic. For example, the prediction system 130 can share the recommendation with the first AP 102, the second AP 104, and/or the third AP 106. The first AP 102, the second AP 104, and/or the third AP 106 can then modify the STA traffic of one or more STAs to perform load balancing. Additionally, the first AP 102, the second AP 104, and/or the third AP 106 can send the recommendation to one or more STAs to notify the one or more STAs to modify operation and indicate the gains when modifying operation. The method 300 concludes at ending block 350.

FIG. 4 is a block diagram of a computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for predicting network throughput and balancing network loads with respect to FIG. 1, FIG. 2 and FIG. 3. Computing device 400, for example, may provide an operating environment for the first AP 102, the second AP 104, the third AP 106, the STAs 120, the edge STAs 122, the prediction system 130, and the like. The first AP 102, the second AP 104, the third AP 106, the STAs 120, the edge STAs 122, the prediction system 130, and the like may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

FIG. 5 illustrates an implementation of a communications device 500 that may implement one or more of the first AP 102, the second AP 104, the third AP 106, the STAs 120, the edge STAs 122, the prediction system 130, controllers, etc., of FIGS. 1-3. In various implementations, the communications device 500 may comprise a logic circuit. The logic circuit may include physical circuits to perform operations described for one or more of the first AP 102, the second AP 104, the third AP 106, the STAs 120, the edge STAs 122, the prediction system 130, controllers, etc., of FIGS. 1-3, for example. As shown in FIG. 5, the communications device 500 may include one or more of, but is not limited to, a radio interface 510, baseband circuitry 530, and/or the computing device 400.

The communications device 500 may implement some or all of the structures and/or operations for the first AP 102, the second AP 104, the third AP 106, the STAs 120, the edge STAs 122, the prediction system 130, controllers, etc., of FIGS. 1-3, storage medium, and logic circuit in a single computing entity, such as entirely within a single device. Alternatively, the communications device 500 may distribute portions of the structure and/or operations using a distributed system architecture, such as a client station server architecture, a peer-to-peer architecture, a master-slave architecture, etc.

A radio interface 510, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 510 may include, for example, a receiver 515 and/or a transmitter 520. The radio interface 510 may include bias controls, a crystal oscillator, and/or one or more antennas 525. In additional or alternative configurations, the radio interface 510 may use oscillators and/or one or more filters, as desired.

The baseband circuitry 530 may communicate with the radio interface 510 to process, receive, and/or transmit signals and may include, for example, an Analog-To-Digital Converter (ADC) for down converting received signals with a Digital-To-Analog Converter (DAC) 535 for up converting signals for transmission. Further, the baseband circuitry 530 may include a baseband or PHYsical layer (PHY) processing circuit for the PHY link layer processing of respective receive/transmit signals. Baseband circuitry 530 may include, for example, a Media Access Control (MAC) processing circuit 540 for MAC/data link layer processing. Baseband circuitry 530 may include a memory controller for communicating with MAC processing circuit 540 and/or a computing device 400, for example, via one or more interfaces 545.

In some configurations, PHY processing circuit may include a frame construction and/or detection module, in combination with additional circuitry such as a buffer memory, to construct and/or deconstruct communication frames. Alternatively or in addition, MAC processing circuit 540 may share processing for certain of these functions or perform these processes independent of PHY processing circuit. In some configurations, MAC and PHY processing may be integrated into a single circuit.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving traffic information from a plurality of Access Points (APs);
based on the traffic information, modeling traffic associated with the plurality of APs;
based on the modeled traffic, modeling a gain in AP efficiency for one or more APs of the plurality of APs when modifying Station (STA) traffic of a STA; and
sending a recommendation to one or more recipient APs of the plurality of APs, wherein the recommendation indicates the gain in AP efficiency for the one or more APs when modifying the STA traffic.

2. The method of claim 1, wherein modifying the STA traffic comprises any one of (i) removing the STA traffic from a current AP of the plurality of APs, (ii) moving the STA traffic to a new AP of the plurality of APs, (iii) reducing an airtime allocation for the STA traffic, or (iv) any combination of (i)-(iii).

3. The method of claim 1, wherein the traffic information comprises any one of (i) information identifying associated STAs, (ii) information identifying a sender and a receiver of traffic, (iii) frame duration information, (iv) Modulation and Coding Scheme (MCS) information, (v) information identifying movement of STAs, (vi) information identifying Multi-Link Device (MLD) capable STAs, (vii) information identifying traffic type, or (viii) any combination of (i)-(vii).

4. The method of claim 1, wherein modeling the traffic associated with the plurality of APs comprises using a regressor to model the traffic based on time series data of the traffic information.

5. The method of claim 1, wherein modeling the traffic associated with the plurality of APs comprises any one of (i) identifying one or more STAs associated to two or more APs of the plurality of APs, (ii) identifying one or more STAs associated to a single AP and capable of associating to one or more neighboring APs, (iii) identifying one or more STAs not capable of associating to one or more neighboring APs, or (iv) any combination of (i)-(iii).

6. The method of claim 1, wherein:
modeling the gain in AP efficiency comprises identifying the STA is an edge STA; and
determining to model the gain in AP efficiency for the one or more APs of the plurality of APs when modifying the STA traffic of the STA is based on identifying the STA is an edge STA.

7. The method of claim 1, wherein modeling the gain in AP efficiency comprises any one of:
(i) using naïve Bayes to evaluate an effect of modifying the STA traffic by moving the STA traffic to a new AP of the plurality of APs; or
(ii) using a regressor coupled with a booster that minimizes uncertainty resulting from modifying the STA traffic by moving the STA traffic to the new AP of the plurality of APs.

8. The method of claim 1, wherein an AP of the one or more recipient APs sends at least a portion of the recommendation to the STA.

9. A system comprising:
a memory storage; and
a processing unit coupled to the memory storage, wherein the processing unit is operative to:
receive traffic information from a plurality of Access Points (APs);
based on the traffic information, model traffic associated with the plurality of APs;
based on the modeled traffic, model a gain in AP efficiency for one or more APs of the plurality of APs when modifying Station (STA) traffic of a STA; and
send a recommendation to one or more recipient APs of the plurality of APs, wherein the recommendation indicates the gain in AP efficiency for the one or more APs when modifying the STA traffic.

10. The system of claim 9, wherein to modify the STA traffic comprises any one of (i) to remove the STA traffic from a current AP of the plurality of APs, (ii) to move the STA traffic to a new AP of the plurality of APs, (iii) to reduce an airtime allocation for the STA traffic, or (iv) any combination of (i)-(iii).

11. The system of claim 9, wherein to model the traffic associated with the plurality of APs comprises to use a regressor to model the traffic based on time series data of the traffic information.

12. The system of claim 9, wherein to model the traffic associated with the plurality of APs comprises any one of (i) to identify one or more STAs associated to two or more APs of the plurality of APs, (ii) to identify one or more STAs associated to a single AP and capable of associating to one or more neighboring APs, (iii) to identify one or more STAs not capable of associating to one or more neighboring APs, or (iv) any combination of (i)-(iii).

13. The system of claim 9, wherein:
to model the gain in AP efficiency comprises to identify the STA is an edge STA; and
to determine to model the gain in AP efficiency for the one or more APs of the plurality of APs when modifying the STA traffic of the STA is based on identifying the STA is an edge STA.

14. The system of claim 9, wherein to model the gain in AP efficiency comprises any one of:
(i) to use naïve Bayes to evaluate an effect of modifying the STA traffic by moving the STA traffic to a new AP of the plurality of APs; or
(ii) to use a regressor coupled with a booster that minimizes uncertainty resulting from modifying the STA traffic by moving the STA traffic to the new AP of the plurality of APs.

15. A non-transitory computer-readable medium that stores a set of instructions which when executed perform a method executed by the set of instructions comprising:
receiving traffic information from a plurality of Access Points (APs);
based on the traffic information, modeling traffic associated with the plurality of APs;
based on the modeled traffic, modeling a gain in AP efficiency for one or more APs of the plurality of APs when modifying Station (STA) traffic of a STA; and
sending a recommendation to one or more recipient APs of the plurality of APs, wherein the recommendation indicates the gain in AP efficiency for the one or more APs when modifying the STA traffic.

16. The non-transitory computer-readable medium of claim 15, modifying the STA traffic comprises any one of (i) removing the STA traffic from a current AP of the plurality of APs, (ii) moving the STA traffic to a new AP of the plurality of APs, (iii) reducing an airtime allocation for the STA traffic, or (iv) any combination of (i)-(iii).

17. The non-transitory computer-readable medium of claim 15, wherein modeling the traffic associated with the plurality of APs comprises using a regressor to model the traffic based on time series data of the traffic information.

18. The non-transitory computer-readable medium of claim 15, wherein modeling the traffic associated with the plurality of APs comprises any one of (i) identifying one or more STAs associated to two or more APs of the plurality of APs, (ii) identifying one or more STAs associated to a single AP and capable of associating to one or more neighboring APs, (iii) identifying one or more STAs not capable of associating to one or more neighboring APs, or (iv) any combination of (i)-(iii).

19. The non-transitory computer-readable medium of claim 15, wherein:
modeling the gain in AP efficiency comprises identifying the STA is an edge STA; and
determining to model the gain in AP efficiency for the one or more APs of the plurality of APs when modifying the STA traffic of the STA is based on identifying the STA is an edge STA.

20. The non-transitory computer-readable medium of claim 15, wherein modeling the gain in AP efficiency comprises any one of:
(i) using naïve Bayes to evaluate an effect of modifying the STA traffic by moving the STA traffic to a new AP of the plurality of APs; or
(ii) using a regressor coupled with a booster that minimizes uncertainty resulting from modifying the STA traffic by moving the STA traffic to the new AP of the plurality of APs.
